(19) United States
(12) Patent Application Publication
(10) Pub. No.: US 2009/0050752 A1
(43) Pub. Date: Feb. 26, 2009

(54) Plasma display device

(76) Inventor: Hyun-Ye Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/219,822

(22) Filed: Jul. 29, 2008

(30) Foreign Application Priority Data
Aug. 23, 2007 (KR) 10-2007-0084912

(51) Int. Cl. G12B 9/10

(52) U.S. Cl. 248/27.1

(57) ABSTRACT

Example embodiments may provide a plasma display device, including a plasma display panel (PDP), and a chassis base adapted to support the PDP. The chassis base may be adapted to slidably receive the PDP.

### BACKGROUND OF THE INVENTION

1. Field of the Invention

Example embodiments relate to a plasma display device, and more particularly, to a plasma display device having a chassis base with an improved structure.

2. Description of the Related Art

A plasma display device may a device that displays an image on a plasma display panel (PDP) using plasma generated by a gas discharge. The plasma display device may include the PDP, a chassis base that supports the PDP, and printed circuit boards (PCB) mounted on the chassis base.

The PDP may be formed by a process of attaching surfaces of two substrates to each other. Further, the PDP may be attached on a front surface of the chassis base with double-sided adhesive tape, for example, and the PCBs may be mounted on a rear surface of the chassis base with bosses and screws, for example.

However, using double-sided adhesive tape to attach the PDP to the chassis base may provide problems, e.g., difficulty in attachment/detachment, time consumption, additional process, etc.

### SUMMARY OF THE INVENTION

Example embodiments are therefore directed to a display device, which may substantially overcome one or more of the problems due to the limitations and disadvantages of the related art.

It is therefore a feature of example embodiments to provide a plasma display device that may reduce the process time of attaching/detaching a PDP and a chassis base.

It is therefore another feature of example embodiments to provide a plasma display device having flexible members between a PDP and a chassis base, so that vibrations and noise from the PDP may be absorbed.

It is therefore another feature of example embodiments to provide a plasma display device having flexible members between a PDP and a chassis base, so that the PDP may be protected from impact from the outside.

At least one of the above and other features of example embodiments may provide a plasma display device, including a plasma display panel (PDP), and a chassis base adapted to support the PDP. The chassis base may be adapted to slidably receive the PDP.

The chassis base may include a first supporting member adapted to support one edge of the PDP, and a second supporting member adapted to support the other edge of the PDP.

The plasma display device may further include a main body positioned between the first supporting member and the second supporting member. The main body may be generally rectangular in shape.

The PDP may include a first substrate, and a second substrate substantially parallel to the first substrate.

The plasma display device may further include a first flexible member. The first flexible member may be provided between the first supporting member and the PDP. The first flexible member may include a first guide groove therein adapted to support and guide a top edge of the PDP.

A width of the first guide groove may be approximately equal to or wider than the top edge of the PDP.

The first guide groove may include a first step portion for supporting the front substrate and a second step portion for supporting the rear substrate.

The plasma display device may further include a second flexible member. The second flexible member may be provided between the second supporting member and the PDP. The second flexible member may include a second guide groove therein adapted to support and guide a bottom edge of the PDP.

The second guide groove may include a first step portion for supporting the front substrate and a second step portion for supporting the rear substrate.

A width of the second guide groove may be approximately equal to or wider than the bottom edge of the PDP.

The second guide groove may further include an opening adapted to receive a flexible PCB. The opening may be shorter than the second guide groove.

The plasma display device may further include a circuit assembly arranged on the chassis base, and the flexible PCB may be provided between the circuit assembly and the PDP. The flexible PCB may pass through the opening. The flexible PCB may pass through the opening and is connected to the PDP.

The opening may have one end of the second supporting member that may be depressed and may extend along the other edge of the PDP.

The opening may be apart from the opposite end of the second supporting member with a distance therebetween.

### BRIEF DESCRIPTION OF THE DRAWINGS

The above and other features and advantages of example embodiments will become more apparent to those of ordinary skill in the art by describing in detail example embodiments thereof with reference to the attached drawings, in which:

FIG. 1 illustrates a perspective view of a front surface of a plasma display device according to an example embodiment;

FIG. 2 illustrates a perspective view of a rear surface of a plasma display device according to an example embodiment;

FIG. 3 illustrates a side view of a plasma display device according to an example embodiment; and

FIG. 4 illustrates a bottom plan view of a plasma display device according to an example embodiment.

### DETAILED DESCRIPTION OF THE INVENTION

Example embodiments will now be described more fully hereinafter with reference to the accompanying drawings. The invention may, however, be embodied in different forms and should not be construed as limited to the embodiments set forth herein. Rather, these example embodiments are provided so that this disclosure will be thorough and complete, and will fully convey the scope of the invention to those skilled in the art.

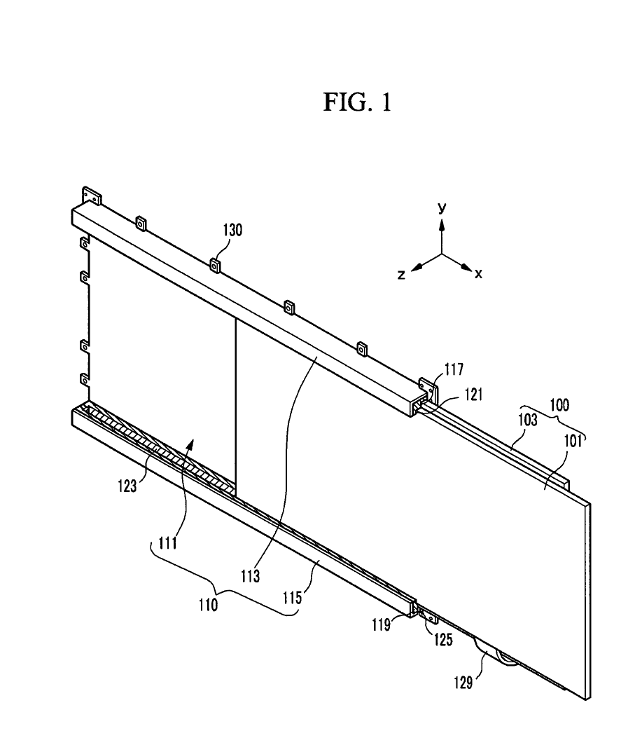

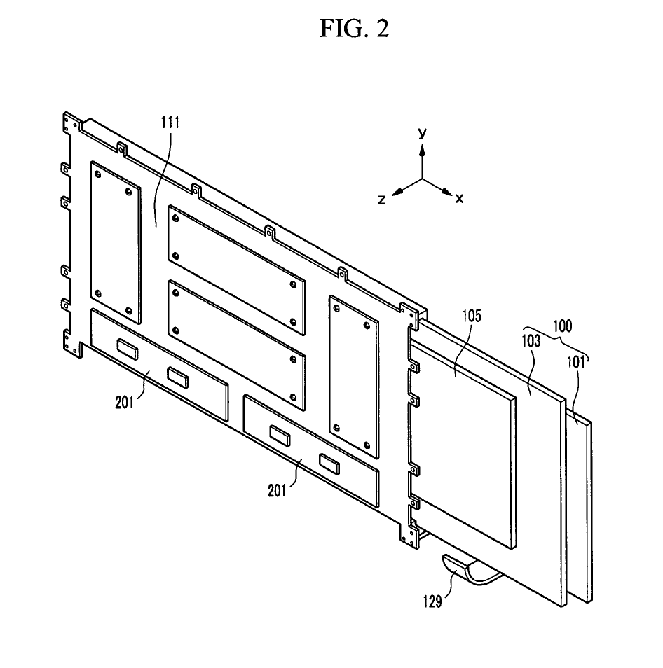

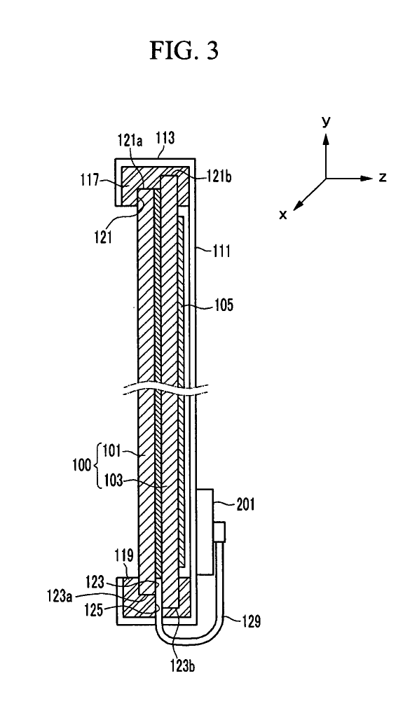

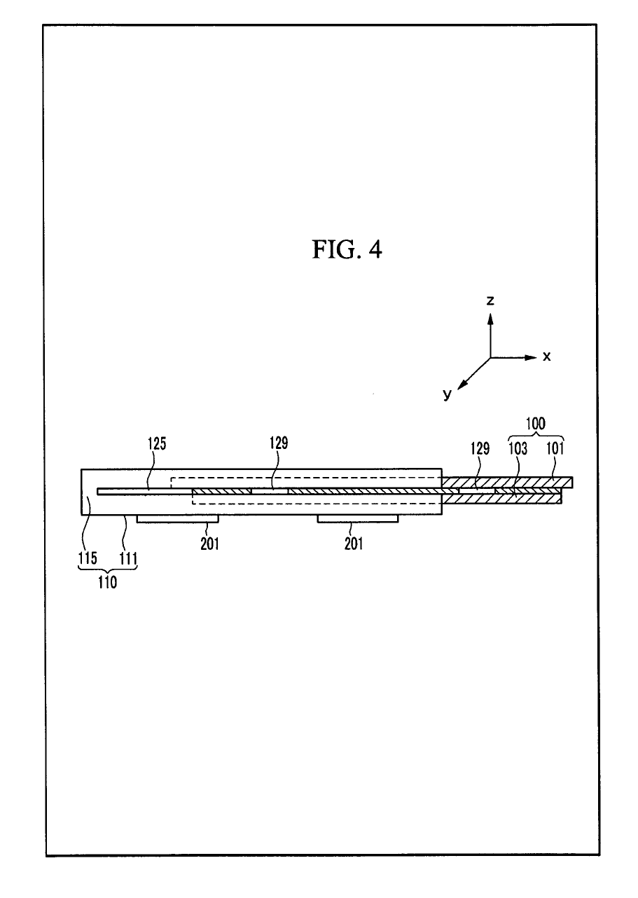

FIG. 1 illustrates a perspective view of a front surface of a plasma display device 10 according to an example embodiment; FIG. 2 illustrates a perspective view of a rear surface of the plasma display device 10; FIG. 3 illustrates a side view of the plasma display device 10; and FIG. 4 illustrates a bottom plan view of the plasma display device 10.

Referring to FIG. 1, the plasma display device 10 may include a plasma display panel (PDP) 100 and a chassis base 110.

The PDP 100 may include a front substrate 101 and a rear substrate 103, which may include discharge cells (not shown) therebetween. The front substrate 101 and the rear substrate 103 may be disposed in parallel, and may face each other with a predetermined interval. At least one of the front substrate 101 and the rear substrate 103 may be formed of a transparent material, e.g., soda lime glass, a semi-transmissible substrate, a reflective substrate, or a colored substrate.

The front substrate 101 and the rear substrate 103 may be generally rectangular, however, it should be appreciated that the substrates 101 and 103 may be formed in other shapes. Further, the front substrate 101 and the rear substrate 103 may each be similar in shape; however, it should be appreciated that the shape of the substrates 101 and 103 may each be different.

A thermally conductive sheet 105 may be attached to the rear surface of the rear substrate 103 so that the heat of the PDP 100 is uniformly distributed. That is, the thermally conductive sheet 105 quickly disperses the heat of the PDP 100 in the planar direction thereof. The thermally conductive sheet 105 may comprises a variety of different materials, such as silicon, urethane, acryl, graphite, metal, or carbon nano-tube material.

As will be described in greater details, the PDP 100 may slidably move in the chassis base 110 along an X-direction, i.e., a right-to-left direction. However, it should be appreciated that the PDP 100 may also move in a left-to-right direction.

The chassis base 110 may be arranged to face the rear substrate 103 of the PDP 100. The chassis base 110 may include a plurality of attachment tabs 130, for inserting attachment devices, e.g., screws, rivets, etc., therethrough, and to be attached to a frame (not shown) of the plasma display device 10.

The chassis base 110 may include a main body 111, a first supporting member 113, a second supporting member 115, a first flexible member 117 and a second flexible member 119.

The main body 111 may be generally rectangular in shape, and may face the rear substrate 103 of the PDP 100. It should be appreciated that the main body 111 may generally conform to the shape of the PDP 100.

The first supporting member 113 and the second supporting member 115 may support either edge (e.g., top and bottom edges) along the X-direction of the PDP 100. The first supporting member 113 and the second supporting member 115 may further extend from top and bottom edges of the PDP 100 toward a front surface of the front substrate 101 of the PDP 100, e.g., the first and second supporting members 113 and 115 may have one part located around a front surface of the PDP 100, and another part located around a rear surface of the PDP 100. The parts located around the front and rear surfaces of the PDP 100 may be generally perpendicular to one other (e.g., face each other). It should be appreciated that the first and second supporting members 113 and 115 may be configured in other various shapes or structures as long as the members 113 and 115 support the edges of the PDP 100.

The first flexible member 117 may be positioned between the top edge of the PDP 100 and the first supporting member 113. The first flexible member 117 may support the top edge of the PDP 100 when the PDP 100 is arranged on the chassis base 110. That is, as the PDP 100 is slid into the chassis base 110 along the X-direction, for example, the first flexible member 117 supports the movement of the PDP 100, and stably supports the PDP 100.

The first flexible member 117 may extend partially toward the front surface of the front substrate 101 and the rear surface of the rear substrate 103 of the PDP 100 (as shown in FIG. 3). The extended portions of the first flexible member 117 may be used as additional support.

Further, the first flexible member 117 may be made from an elastic material, e.g., a rubber and/or a synthetic resin. It should be appreciated that the first flexible member 117 may be made from other materials. Accordingly, the first flexible member 117 may absorb vibrations and/or noise from the PDP 100 after the PDP 100 is positioned in the chassis base 110. Also, the first flexible member 117 may protect the PDP 100 by absorbing impacts from outside the PDP 100.

The second flexible member 119 may be arranged between the bottom edge of the PDP 100 and the second supporting part 115, and may have a similar function, structure and role as the first flexible member 117. Thus, the description of the second flexible member 119 will be omitted for brevity sake.

Although example embodiments describe the first and second flexible members 117 and 119 extending an entire length (or edge-to-edge) of the first and second supporting members 113 and 115, respectively, it should be appreciated that the first and second flexible members 117 and 119 may be formed in intervals (e.g., separate units distributed along the length rather than as a whole unit).

Referring to FIG. 1 and FIG. 3, the first flexible member 117 may form a first guide groove 121 (e.g., depressed by a certain depth). Similarly, the second flexible member 119 may form a second guide groove 123 (e.g., depressed by a certain depth) and an opening 125.

The first guide groove 121 may include a first step portion 121a for supporting the front substrate 101 and a second step portion 121b for supporting the rear substrate 103. In an example embodiment, the second step portion 121b may be higher than the first step portion 121a (as shown in FIG. 3). However, it should be appreciated that the second step portion 121a may be lower than the first step portion 121a. It should further be appreciated that the first guide groove 121 may be uniform (no step portions), depending on the shape of the top edges of the front and rear substrates 101 and 103.

The first guide groove 121 may have a width approximately equal to or wider than a width of the top edge of the PDP 100. Further, the first guide groove 121 may extend along the X-direction (e.g., right-to-left direction), and may have a length approximately equal to or longer than the length of the top edge of the PDP 100. Further, one end (e.g., a right end) of the first guide groove 121 may be open to the outside so that the PDP 100 may slide into the chassis 110 from the right. In the alternative, the other end (e.g., a left end) of the first guide groove 121 may be open so that the PDP 100 may slide into the chassis 110 from the left.

The second guide groove 121 may include a first step portion 123a for supporting the front substrate 101 and a second step portion 123b for supporting the rear substrate 103 at the bottom surface thereof. In an example embodiment, the second step portion 123b may be lower than the first step portion 123a (as shown in FIG. 3). However, it should be appreciated that the second step portion 121a may be higher than the first step portion 121a. It should further be appreciated that the first guide groove 121 may be uniform (no step portions), depending on the shape of the bottom edges of the front and rear substrates 101 and 103.

The second guide groove 123 may have a width approximately equal to or wider than the bottom edge of the PDP 100. Further, the second guide groove 123 may extend along the X-direction (e.g., right-to-left direction), and may have a length approximately equal to or longer than the length of the bottom edge of the PDP 100. Further, one end (e.g., a right end) of the second guide groove 123 may be open to the outside so that the PDP 100 may slide into the chassis 110 from the right. In the alternative, the other end (e.g., a left end) of the second guide groove 123 may be open so that the PDP 100 may slide into the chassis 110 from the left.

One skilled in the art should appreciate that the open ends of the first and second guide grooves 121 and 123 should be open at the same end.

The opening 125 in the second guide groove 123 may be formed within the second guide groove 123, and may be used as a path for the flexible PCB 129. The opening 125 may extend in the X-direction, and may have a length approximately equal to the length of the second supporting member 115. One skilled in the art will appreciate that the term “opening” may be interpreted as a gap, aperture, hole, cavity, etc.

The opening 125 may be formed in the second supporting part 115 such that a flexible PCB 129 may pass through the opening 125. Therefore, the opening 125 may have a width approximately equal to or wider than that of the flexible PCB 129.

The opening 125 may be formed to be as long as the second guide groove 123 (in the X-direction). However, it should be appreciated that the opening 125 may be formed to be shorter than the second guide groove 123, depending on a location of the flexible PCB 129. That is, the opening 125 may have similar length to that of the second guide groove 123 when the flexible PCB 129 is located near the left edge of the PDP 100. Hence, when the flexible PCB 129 is located away from the left edge of the PDP 100, the opening 125 may be shorter than the second guide groove 123.

Further, the opening 125 may be formed by a process such that one end of the second supporting member 115 may be depressed and may extend along the other edge of the PDP 100. The opening 125 may be formed apart from the opposite end of the second supporting member 115 with a distance therebetween.

Referring to FIGS. 2 and 4, a circuit assembly 201 may be positioned on the main body 111 of the chassis base 110. The circuit assembly 201 may be connected to the flexible PCB 129, and may provide various data, e.g., electrical signals to the PDP 100. In an example embodiment, one end of the flexible PCB 129 may be connected to the front substrate 101 and the other end may be connected to the circuit assembly 201. However, it should be appreciated that the flexible PCB 129 may be connected to other devices, e.g., rear substrate 103.

It should further be appreciated that there may be more than one circuit assembly 201 and/or flexible PCB 129 in the plasma display device 10. It should further be appreciated that other various devices, besides the flexible PCB 129, may be employed as long as the devices are able to provide data between the PDP 100 and the circuit assembly 210.

In assembling the plasma display device 10, the PDP 100 may be slid into the chassis base 110 from the X-direction, e.g., right to left, via engaging the top edge of the PDP 100 to the first flexible member 117 and the bottom edge of the PDP 100 to the second flexible member 119. After sliding the PDP 100 into the chassis 110, the flexible PCB 129 (which may be detached to the circuit assembly 201) may then passes through the opening 125 to be slid therein. After the PDP 100 is connected to the chassis base 110, the flexible PCB 129 may then be connected to the circuit assembly 201, so as to provide data from the circuit assembly 201.

Example embodiments provide the PDP 100 detached from the chassis base 110 by dissembling the flexible PCB 129 and the circuit assembly 201 and then sliding the PDP 100 in the X-direction. Thus, the PDP 100 may quickly and efficiently detach and re-attach from the chassis base 110.

Example embodiments provide a process for reducing time to attach/detach the PDP to the chassis base.

Example embodiments provide a plasma display device having flexible members between the PDP and the chassis base so that vibrations and noise from the PDP may be absorbed.

Example embodiments provide a plasma display device having flexible members between the PDP and the chassis base so that the PDP may be protected from impact from the outside.

In the figures, the dimensions of elements and regions may be exaggerated for clarity of illustration. It will also be understood that when an element is referred to as being “on”, “connected to” or “coupled to” another element it can be directly on, connected or coupled to the other element or intervening elements may be present. In contrast, when an element is referred to as being “directly on,” “directly connected to” or “directly coupled to” another element, there are no intervening elements present. Further, it will be understood that when an element is referred to as being “under” or “above” another element, it can be directly under or directly above, and one or more elements may also be present. In addition, it will also be understood that when an element is referred to as being “between” two elements, it can be the only element between the two elements, or one or more intervening element may also be present. Like numbers refer to like elements throughout. As used herein, the term “and/or” includes any and all combinations of one or more of the associated listed items.

It will also be understood that, although the terms “first”, “second,” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of exemplary embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or features described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plasma display panel (PDP); and
a chassis base adapted to support the PDP,
wherein the chassis base is adapted to slidably receive the PDP.

2. The plasma display device as claimed in claim 1, wherein the chassis base includes:
a first supporting member adapted to support one edge of the PDP; and
a second supporting member adapted to support the other edge of the PDP.

3. The plasma display device as claimed in claim 2, further comprising a main body positioned between the first supporting member and the second supporting member.

4. The plasma display device as claimed in claim 3, wherein the main body is generally rectangular in shape.

5. The plasma display device as claimed in claim 1, wherein the PDP includes:
a first substrate; and
a second substrate substantially parallel to the first substrate.

6. The plasma display device as claimed in claim 5, further comprising a first flexible member, the first flexible member is provided between the first supporting member and the PDP.

7. The plasma display device as claimed in claim 6, wherein the first flexible member includes a first guide groove therein adapted to support and guide a top edge of the PDP.

8. The plasma display device as claimed in claim 7, wherein a width of the first guide groove is approximately equal to or wider than the top edge of the PDP.

9. The plasma display device as claimed in claim 7, wherein the first guide groove includes a first step portion for supporting the front substrate and a second step portion for supporting the rear substrate.

10. The plasma display device as claimed in claim 5, further comprising a second flexible member, the second flexible member is provided between the second supporting member and the PDP.

11. The plasma display device as claimed in claim 10, wherein the second flexible member includes a second guide groove therein adapted to support and guide a bottom edge of the PDP.

12. The plasma display device as claimed in claim 11, wherein the second guide groove includes a first step portion for supporting the front substrate and a second step portion for supporting the rear substrate.

13. The plasma display device as claimed in claim 11, wherein a width of the second guide groove is approximately equal to or wider than the bottom edge of the PDP.

14. The plasma display device as claimed in claim 11, wherein the second guide groove further comprising an opening adapted to receive a flexible PCB.

15. The plasma display device as claimed in claim 14, wherein the opening is shorter than the second guide groove.

16. The plasma display device as claimed in claim 14, further comprising a circuit assembly arranged on the chassis base, and the flexible PCB is provided between the circuit assembly and the PDP.

17. The plasma display device as claimed in claim 16, wherein the flexible PCB passes through the opening.

18. The plasma display device as claimed in claim 17, wherein the flexible PCB passes through the opening and is connected to the PDP.

19. The plasma display device as claimed in claim 17, wherein the opening has one end of the second supporting member that is depressed and extends along the other edge of the PDP.

20. The plasma display device as claimed in claim 17, wherein the opening is apart from the opposite end of the second supporting member with a distance therebetween.
